(19) United States
(12) Patent Application Publication
(10) Pub. No.: US 2009/0226752 A1
(43) Pub. Date: Sep. 10, 2009

(54) ELECTRODES

(76) Inventors: David Steven Barratt, Blackburn (GB); Derek John Holden, Blackburn (GB)

Correspondence Address: TREGO, HINES & LADENHEIM, PLLC, 9300 HARRIS CORNERS PARKWAY, SUITE 210, CHARLOTTE, NC, 28269-3797, US

(21) Appl. No.: 12/094,033

(22) PCT Filed: Nov. 17, 2006
(86) PCT No.: PCT/GB06/04297

§ 371 Date: Sep. 4, 2008

(30) Foreign Application Priority Data
Nov. 18, 2005 (GB) 0523474.5

(51) Int. Cl. H01J 61/09; H01R 43/16

(52) U.S. Cl. 428/595; 29/874

(57) ABSTRACT

There are provided electrode components (1) comprising an open ended tube and a plug and electrodes and electrical apparatus comprising the same. Also provided are methods of forming electrode components.

### FIELD OF THE INVENTION

The present invention relates to electrodes, electrode components and apparatus comprising electrodes as well as to methods of manufacturing electrodes and electrode components.

### BACKGROUND TO THE INVENTION

There are known electrodes having a range of constructions and applications. Cold cathode electrodes for example have been found effective for lighting applications including cold cathode fluorescent lamps (CCFL) as backlights for LCD displays. However, such electrodes are of a small size and can thus be difficult to manufacture.

A known electrode comprises Molybdenum and has a tubular body which is blind at one end and to which end a stem (or pin) is attached. The tubular body is formed in a single part by a deep-drawing process and may consequently have a number of disadvantages.

The deep-drawing process can be inefficient resulting in wastage of materials and consequently increased manufacturing costs.

Additionally, with a deep drawing process the length of the tubular body may be restricted to a maximum of around 5 times its diameter. However, for longer electrode life and greater lamp brightness, longer electrodes having higher surface areas are desirable.

To improve the electrodes performance and/or lifespan it may also be desirable to coat the inner and/or outer surfaces of the tubular body. However, it may be difficult to coat the inside of the body, particularly if the body is long.

There thus remains a need for alternative electrodes and manufacturing methods.

Accordingly, the present invention aims to address at least one disadvantage associated with the prior art whether discussed herein or otherwise.

### SUMMARY OF INVENTION

According to a first aspect of the present invention there is provided an electrode component comprising an open ended tube and a plug, wherein the tube comprises a metal sheet which is formed into a tubular configuration and the plug is located within the tube to form a tubular body which is blind at one end.

Suitably, the component comprises an electrode emission source component.

Suitably, the tubular body has an outer diameter of between 0.5 and 5 mm.

Suitably, the tubular body has a length of between 1 and 20 times its diameter, preferably between 3 and 15 times its diameter, for example around 10 times its diameter.

Suitably, the length of the tubular body is at least 5 times its diameter, for example at least 6, 7, 8, 9, 10, 11 or 12 times its diameter. Such ratios may result in a lamp comprising an electrode which comprises the electrode emission source component having a longer lifetime and/or greater brightness than lamps employing known electrodes.

Suitably, the plug comprises a head portion arranged to locate within the tube.

The plug may consist of a head portion arranged to be connected to a stem. Alternatively, the plug may comprise a head portion and a stem connected thereto. The electrode component may thus comprise an electrode. The head and stem may comprise a unitary body. Alternatively, they may be formed in two parts.

The plug may have a substantially T-shaped cross section if it comprises a stem and head portion.

The plug may be formed by casting. Alternatively, it may be formed by a drawing process if appropriate or the head may be pressed and the stem may be cut from a rod.

The head portion may be welded to a stem. Alternatively, the head portion may be provided with an aperture into which a stem can be inserted. The head portion may comprise a disc having an aperture and may thus comprise a washer. Suitably, the stem diameter is slightly greater than the diameter of the head portion aperture. The stem may thus be a forced fit into the head portion aperture.

The use of a forced fit may reduce or eliminate the need to weld the stem and head portion to one another and may thus reduce recrystallisation of the plug. It may also provide good thermal conductivity between the parts and may simplify manufacture as the stem can be cut from a metal rod and washers can be easily pressed out.

Suitably, the plug is arranged to locate within an end of the tube such that the plug fits snugly therein. Suitably, the tube overlaps only a head portion of the plug.

Suitably, the plug is located within the tube such that the tube overlaps the plug by between 0.1 and 30% of the tube length, preferably by between 0.5 and 20% of the tube length, for example by between 2 and 15% of the tube length.

Suitably, the tube overlaps the plug by between 0.1 mm and 10 mm. More preferably, the tube overlaps the plug by between 0.1 mm and 1 mm. Suitably, the tube overlaps the plug by at least 0.1 mm, preferably by at least 0.3 mm, for example by at least 0.5 mm.

Suitably, the head portion comprises a disc which may be substantially circular. Suitably, the disc has a diameter arranged such that it fits snugly within the tube.

The disc may have a diameter of between 0.45 and 4.98 mm.

Suitably, the disc has a thickness of between 0.01 and 10 mm, preferably between 0.01 to 1 mm, more preferably between 0.02 and 1 mm, for example 0.5 mm.

The metal sheet of the tube may be rolled into a tubular configuration. Suitably, the metal sheet is bent into a tubular configuration.

Suitably, the tube has a substantially circular cross section.

Suitably, the tube comprises a bent metal sheet which is substantially planar prior to being formed into the tube. Suitably, the tube comprises a bent metal sheet which is substantially rectangular prior to being formed into the tube.

Suitably, opposed first and second edges of the metal sheet lie substantially adjacent one another when formed into the tube.

Suitably, first and second edge regions of the metal sheet overlap when formed into the tube. The tube may thus have a double wall thickness at a seam which closes the tube circumferentially.

Suitably, first and second edge regions of the metal sheet overlap by between 0.1% and 10% of the circumference of the tube, when formed into the tube, for example by between 0.5% and 8%.

Suitably, the metal sheet has a thickness of between 0.01 and 0.1 mm, preferably between 0.02 and 0.1 mm, for example around 0.08 mm. The tube may thus have a wall having a thickness of between 0.01 and 1 mm, preferably between 0.02 and 0.1 mm, for example around 0.08 mm. The wall may have double this thickness where edges of the metal sheet overlap.

Suitably, the electrode component comprises one or more welds to secure the bent metal sheet in a tubular configuration.

Suitably, one or more welds are formed to join overlapping parts of the metal sheet. Suitably, overlapping parts of the metal sheet are laser welded together. Suitably, the welds are spot welds.

Suitably, the tube is secured to the plug by one or more welds. Suitably, the tube and plug are laser welded together. Suitably, the welds are spot welds.

Suitably, the tube is secured to the plug by a first weld located at a region in which the first and second edges of the metal sheet overlap and in which the tube and plug overlap. Suitably, the tube and plug are secured by one or more further welds, preferably by two further welds spaced between 90 and 150 degrees, for example around 120 degrees, either side of the first weld.

Suitably, the tube comprises a metal sheet which comprises a pure metal. Alternatively, the tube may comprise a metal sheet which comprises an alloy.

Suitably, the metal sheet has a melting point of greater than 1100° C. Suitably, the metal sheet has a thermal conductivity of between 0.2 Watts/cm²·° C. and 5.0 Watts/cm²·° C. Suitably, the metal sheet has a coefficient of linear expansion of between 1×10⁻⁶/° C. and 30×10⁻⁶/° C. at ambient temperature.

Suitably, the tube comprises a metal sheet which comprises a transition metal. Suitably, the tube comprises a metal sheet which comprises a metal selected from the group consisting of Steel (ferrous) alloys such as Kovar, Nickel (Ni), refractory metals such as Molybdenum (Mo), Niobium (Nb), Tantalum (Ta) and Tungsten (W) or alloys and/or mixtures thereof. Suitably, the metal sheet comprises Molybdenum. Alternatively, the metal sheet may comprise Nickel which may be coated on at least one side.

The plug head portion may comprise a pure metal. Alternatively, the plug head portion may comprise an alloy.

The plug stem may comprise a pure metal. Alternatively, the plug stem may comprise an alloy.

Suitably, the plug head portion and/or stem has a melting point of greater than 1100° C. Suitably, the plug head portion and/or stem has a thermal conductivity of between 0.2 Watts/cm²·° C. and 5.0 Watts/cm²·° C. Suitably, the plug head portion and/or stem has a coefficient of linear expansion of between 1×10⁻⁶/° C. and 30×10⁻⁶/° C. at ambient temperature.

Suitably, the plug head portion and/or stem comprises a transition metal. Suitably, the plug head portion and/or stem comprises a metal selected from the group consisting of Steel (ferrous) alloys, for example Kovar, Nickel (Ni), refractory metals such as Molybdenum (Mo), Niobium (Nb), Tantalum (Ta), and Tungsten (W) or alloys and/or mixtures thereof. Suitably, the plug head portion and/or stem comprises Molybdenum.

Suitably, the plug head portion and tube comprise the same metal. Alternatively, the plug head portion and tube may comprise distinct metals. The tube and plug head portion may thus be made from distinct materials chosen for their specific properties and functional performance in the overall electrode component combination.

Suitably, the plug head portion and stem comprise the same metal. Alternatively, the plug head portion and stem comprise distinct metals. The stem and plug head portion may thus be made from distinct materials chosen for their specific properties and functional performance in the overall electrode component combination.

Suitably, the inner face of the electrode component comprises a surface coating. The surface coating may be provided on the tube and plug or just on the tube or just on the plug.

Suitably, the tube comprises a metal sheet which is provided with a surface coating on a first side and then formed into a tube such that said first side forms the inner face of the tube. Thus, it may be possible to form a tubular body having a tube of substantial length which is coated substantially evenly over its inner extent.

The surface coating may be arranged to improve the performance and/or lifespan of the electrode component.

The surface coating may have a thickness of between 0.001 mm and 0.1 mm.

The surface coating may comprise micro and/or nano sized particles to increase the surface area of the electrode component. This may result in higher brightness and/or lower operating temperatures for lamps employing electrodes comprising the electrode emission source component.

The surface coating may comprise a metal which has a higher activity than the metal forming the component that it coats. A metal having a higher activity may have an increased resistance to ion bombardment and/or improved electron emission properties which may be due to the metal having a lower work function and/or higher electrical conductivity. The surface coating may comprise Molybdenum or Tungsten or Barium-Aluminium alloys or other suitable elements or alloys. The electrode emission source component may thus be constructed from a plug and/or tube comprising a metal, such as Nickel, coated with a more active but more expensive metal, such as Molybdenum or Tungsten or Barium-Aluminium alloy. This may allow effective electrodes to be manufactured more economically.

The active coating material may comprise an alloy comprising Mercury. Suitably, the active material comprises an alloy comprising Barium, for example Barium-Aluminium, and Mercury. The active material may comprise a Ba—Al and Hg alloy. The inclusion of Mercury may, in use, counteract difficulties associated with the removal of Mercury (Hg) vapour within a lamp by reaction with Barium (Ba). Thus, the use of such an alloy may improve lamp brightness and/or efficiency.

The surface coating may comprise a material having a low work function and/or high resistance to ion bombardment. The surface coating may for example comprise diamond or polycrystalline silicon.

The outer face of the electrode component may comprise a surface coating.

The surface coating may be provided on the tube and plug or just on the tube or just on the plug.

The tube may comprise a metal sheet which is provided with a surface coating on a second side and then formed into a tube such that said second side forms the outer face of the tube.

The surface coating may be arranged to improve the performance and/or lifespan of the electrode component.

The surface coating may comprise a coating as described in relation to the inner face of the electrode component.

The surface coating applied to the outer face may be the same as that applied to the inner face or may be distinct there from. Thus, a surface coating applied to the second side of the metal sheet may be the same as that applied to a first side of the metal sheet or may be distinct there from.

A surface coating may be applied to a part of the electrode component by a number of known methods, for example any of sputter coating, electrochemical deposition, metal-organic vapour phase deposition, in-situ precipitation, sol-gel processes, spraying, brushing or coil coating may be suitable.

Suitably, the surface coating comprises a metal which has a higher activity than the metal forming the component part that it coats.

Once the coating is applied it may be necessary to convert it to a suitable metallic form by a thermal and/or chemical treatment before the part of the electrode component is employed to manufacture the electrode component.

The tube may comprise a metal sheet which is provided with a surface coating which is then converted into a suitable metallic form prior to the metal sheet being formed into a tube.

According to a second aspect of the present invention there is provided an electrode comprising an electrode component according to the first aspect, wherein a stem is attached to a head portion of the plug of the electrode component.

The stem may be formed integrally with the plug. Alternatively, the stem may be connected to the plug head portion. The stem may be welded to the plug head portion and/or connected to the plug head portion by means of a forced fit.

Suitably the stem extends substantially parallel to the axis of the tube. Suitably, the tube and stem have a substantially common axis.

Suitably, the electrode comprises a glass ring mounted on the stem. The glass ring may provide an attachment point by which the electrode may be secured into a housing.

According to a third aspect of the present invention there is provided an electrical apparatus comprising an electrode component according to the first aspect and/or an electrode according the second aspect.

The electrical apparatus may comprise a lighting apparatus. The electrical apparatus may comprise a cold-cathode fluorescent lamp, used for example in a back light for an LCD display.

According to a fourth aspect of the present invention there is provided a method of forming an electrode component according to the first aspect, wherein the method comprises forming a tube by wrapping a metal sheet around a forming member such that the metal sheet adopts a tubular configuration substantially corresponding to the outer face of the forming member and locating a plug within the tube to form a tubular body which is blind at one end.

The forming member may comprise a forming pin of a forming apparatus and plug may be located within a tube subsequent to a tube forming step. Alternatively, the forming member may comprise a head portion of a plug and the metal sheet may be wrapped around the head portion of the plug such that the plug is located within the tube to form said tubular body which is blind at one end. Thus, the step of locating a plug within the tube may be performed simultaneously with the tube forming process.

Suitably, the metal sheet is wrapped around a forming member by a plurality of form fingers. The form fingers may press the metal sheet against the forming member to form the tube.

Suitably, the forming member comprises a substantially cylindrical cross section. Suitably, the forming member comprises a substantially circular cross section. Alternatively, the forming member may comprise: a square, rectangular or triangular cross section.

The metal sheet may be such that once formed into the tubular configuration it substantially retains said configuration.

Suitably, the method comprises the step of securing the metal sheet in the tubular configuration. Said securement step may comprise welding edges of the metal sheet together in the tubular configuration.

Alternatively, or in addition, the securement step may comprise securing the tube onto the plug which may hold the metal sheet in the tubular configuration. The tube and plug may be welded together.

The method may comprise attaching a stem to a head portion of a plug such that an electrode is manufactured.

Alternatively, the plug may comprise a stem and head portion such that the electrode component manufactured by the method may comprise an electrode.

The method may comprise locating a stem into an aperture of a head portion of a plug such that the two are connected by means of a forced fit.

The method may comprise pressing out a head portion, cutting a stem from a rod and connecting the two.

The method may further comprise a method of manufacturing an electrode according to the second aspect and/or an electrical apparatus according to the third aspect.

### BRIEF DESCRIPTION OF THE DRAWINGS

The present invention will now be illustrated by way of example with reference to the accompanying drawings in which:

FIG. 1 is a perspective view of an electrode component showing hidden detail;

FIG. 2 is a cross section of the electrode component of FIG. 1 (inverted);

FIG. 3 is an end view of the electrode component of FIG. 1; and

FIG. 4 is a cross section of a cold-cathode fluorescent lamp comprising the electrode component of FIGS. 1 to 3 and showing hidden detail.

### DESCRIPTION OF THE PREFERRED EMBODIMENTS

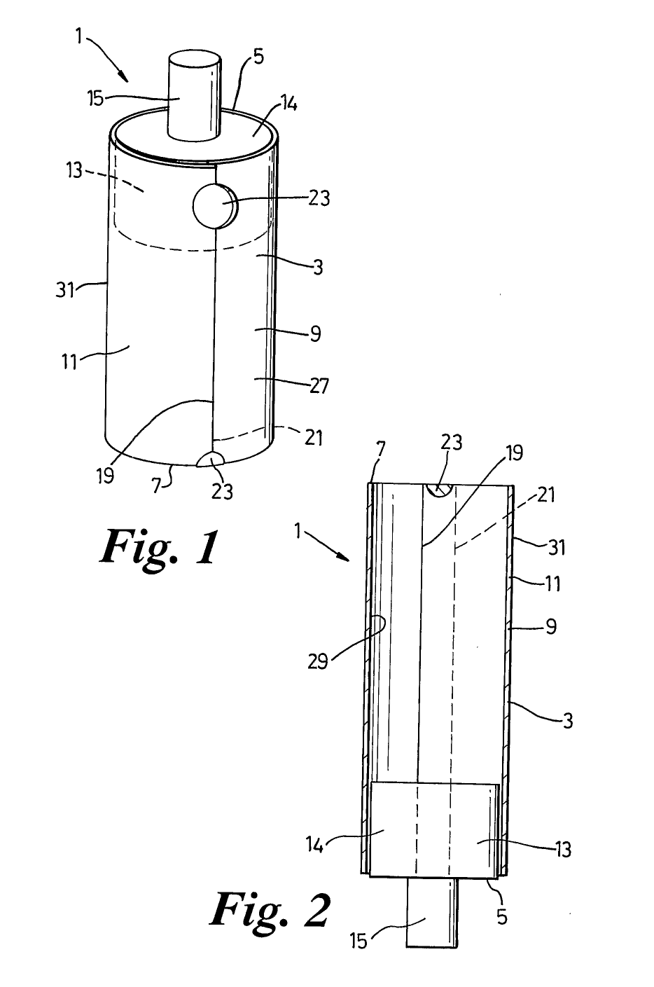

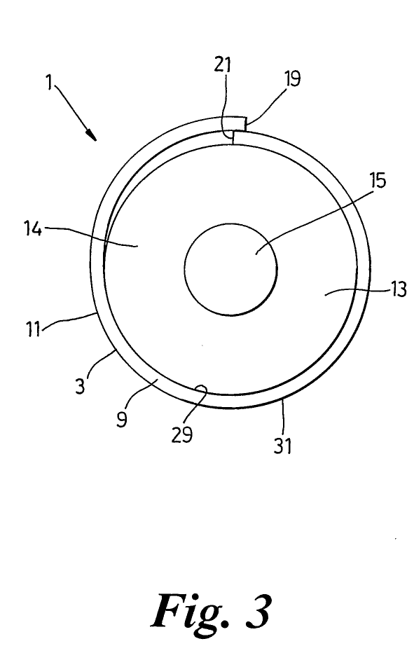

As illustrated by FIGS. 1 to 3 an electrode component 1 comprises a tubular body 3 which is blind at a first end 5 and open at an opposed second end 7. The tubular body 3 comprises a tube 9 formed from a bent metal sheet 11 and a plug 13 (shown in dotted outline in FIG. 1) over which the tube 9 is located.

In the illustrated embodiment the plug 13 comprises a head portion 14 comprising a circular disc and a stem 15 attached thereto. The stem 15 and the head portion 14 are integrally formed and the electrode component 1 thus comprises an electrode. In this embodiment the plug 13 comprises molybdenum and is formed by casting. In an alternative embodiment (not shown) the plug 13 comprises only a head portion 14 and a separate stem 15 must be subsequently attached thereto to form an electrode.

In the illustrated embodiment the metal sheet 11 comprises molybdenum and is fabricated into a tube 9 by being bent. The metal sheet 11 is bent such that first and second edge regions 19, 21 thereof overlap. A first side 25 of the metal sheet forms an inner face 29 of the electrode component 1 and a second side 27 forms an outer face 31 thereof.

The head portion 14 of the plug 13 and the tube 9 are laser welded at weld points 23 to secure the tube 9 to the plug 13 and to retain the metal sheet 11 in a tubular configuration. A first weld point is located within a zone in which the plug 13 and edge regions 19, 21 of the tube 9 overlap. Two further weld points are spaced around the plug 13 within a zone which overlaps with the tube 9 such that they lie approximately 120 degrees either side of the first weld point. An additional weld point is located at the second end 7 of the tubular body 3 within a zone in which the edge regions 19, 21 overlap.

The electrode component 1 has a length of around 3 mm and a diameter of around 1 mm.

In the illustrated embodiment the tube 9 is fabricated by wrapping the metal sheet 11 around a forming member comprising a forming pin (not shown). The metal sheet 11 is pressed against the forming pin such that it adopts a tubular configuration substantially corresponding to the outer face of the forming member.

To form the electrode component 1 the head 14 of the plug 13 is then located into the tube 9 and the plug 13 and tube 9 are laser welded together.

In an alternative embodiment the head 14 of the plug 13 is itself used as the forming member such that the head 14 of the plug 13 is located within the tube 9 as it is formed.

In the illustrated embodiment the plug 13 and tube 9 comprise the same uncoated metal but in alternative embodiments they can comprise distinct metals or one or both can be coated.

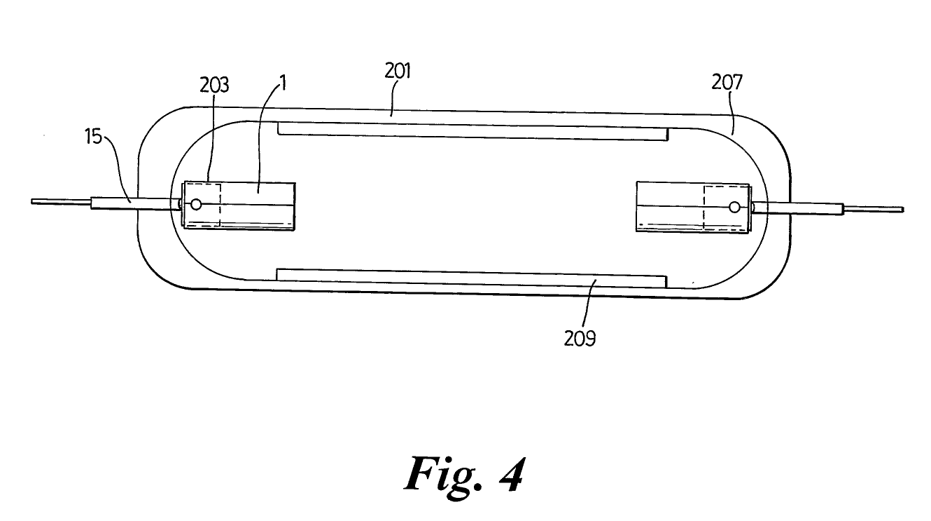

FIG. 4 illustrates a cold cathode fluorescent lamp 201 comprising electrodes 203 each comprising an electrode component 1 including a stem 15. The lamp 201 comprises a glass body (housing) 207 through which the stems 15 extend. The interior of the glass body 207 is provided with a phosphor coating 209 and the body 207 is evacuated and charged with a small quantity of mercury.

In an alternative embodiment (not shown) an electrode component comprises a plug having a head portion and a stem connected thereto. The head portion comprises a disc formed with a central aperture such that it comprises a washer. The stem has a diameter slightly greater than that of the aperture of the head portion and thus is a forced fit into the aperture. The head portion and stem can thus be held connected by means of the forced fit. Otherwise, the electrode component is as described for the illustrated embodiment.

It will be appreciated that electrode components according to preferred embodiments of the present invention may be advantageous. In particular, they may be efficient to produce and may have enhanced lifetimes compared to known components.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or, to any novel one, or any novel combination, of the steps of any method or process so disclosed.

1. An electrode component comprising an open ended tube and a plug, wherein the tube comprises a metal sheet which is formed into a tubular configuration and the plug is located within the tube to form a tubular body which is blind at one end.

2. A component according to claim 1, wherein the component comprises an electrode emission source component.

3. A component according to claim 1, wherein the plug comprises a head portion and a stem connected thereto.

4. A component according to claim 1, wherein the plug comprises a head portion arranged to be connected to a stem.

5. A component according to claim 3, wherein the head portion comprises a substantially circular disc having a diameter of between 0.45 and 4.98 mm.

6. A component according to claim 3, wherein the head portion comprises a disc having a thickness of between 0.1 and 1 mm.

7. A component according to claim 3, wherein the plug has a substantially T-shaped cross section.

8. A component according to claim 1, wherein the tubular body has an outer diameter of between 0.5 and 5 mm.

9. A component according to claim 1, wherein the length of the tubular body at least 5 times its diameter.

10. A component according to claim 1, wherein first and second edge regions of the metal sheet overlap by between 0.1% and 10% of the circumference of the tube, when formed into the tube.

11. A component according to claim 1, wherein the plug is located within the tube such that the tube overlaps the plug by between 0.1 and 30% of the tube length.

12. A component according to claim 11, wherein the tube overlaps only a head portion of the plug.

13. A component according to claim 1, wherein the component comprises one or more welds to secure the formed bent metal sheet in a tubular configuration.

14. A component according to claim 1, wherein the tube is secured to the plug by one or more welds.

15. A component according to claim 1, wherein the metal sheet comprises a pure metal.

16. A component according to claim 1, wherein the metal sheet comprises an alloy.

17. A component according to claim 1, wherein the metal sheet comprises a metal selected from the group consisting of steel (ferrous) alloys, Nickel (Ni), Molybdenum (Mo), Niobium (Nb), Tantalum (Ta) and Tungsten (W) and alloys thereof, and mixtures thereof.

18. A component according to claim 1, wherein the plug comprises a pure metal.

19. A component according to claim 1, wherein the plug comprises an alloy.

20. A component according to claim 1, wherein the plug comprises a metal selected from the group consisting of Steel (ferrous) alloys, Nickel (Ni), Molybdenum (Mo), Niobium (Nb), Tantalum (Ta) and Tungsten (W) and or alloys thereof and mixtures thereof.

21. A component according to claim 1, wherein the plug and tube comprise the same metal.

22. A component according to claim 1, wherein the plug and tube comprise distinct metals.

23. A component according to claim 1, wherein an inner face of the electrode component comprises a surface coating.

24. A component according to claim 23, wherein the metal sheet is provided with a surface coating on a first side and then formed into a tube such that said first side forms the inner face of the tube.

25. A component according to claim 1, wherein an outer face of the electrode component comprises a surface coating.

26. A component according to claim 25, wherein the metal sheet is provided with a surface coating on a second side and then formed into a tube such that said second side forms the outer face of the tube.

27. A component according to claim 23, wherein the surface coating comprises a metal which has a higher activity than the metal forming the component part that it coats.

28. A component according to claim 25, wherein the surface coating comprises a metal which has a higher activity than the metal forming the component part that it coats.

29. An electrode comprising an electrode component according to claim 3.

30. An electrical apparatus comprising an electrode component according to claim 1.

31. A method of forming an electrode component according to claim 1, wherein the method comprises forming a tube by wrapping a metal sheet around a forming member such that the metal sheet adopts a tubular configuration substantially corresponding to the outer face of the forming member and locating a plug within the tube to form a tubular body which is blind at one end.

32. A method according to claim 31, wherein the forming member comprises a forming pin of a forming apparatus and the plug is located within a tube subsequent to a tube forming step.

33. A method according to claim 31, wherein the forming member comprises a head portion of a plug and the metal sheet is wrapped around the head portion of the plug such that the plug is located within the tube to form said tubular body which is blind at one end.

34. A method according to claim 31, wherein the metal sheet is wrapped around a forming member by a plurality of form fingers.

35. A method according to claim 31, wherein the method comprises the step of securing the metal sheet in the tubular configuration.

36. A method according to claim 31, wherein the tube and plug are welded together.

37. A method according to claim 31, wherein a stem is attached to a head portion of a plug such that an electrode is manufactured.

38. A method according to claim 31, wherein the plug comprises a stem and head portion such that an electrode is manufactured by the method.

39. (canceled)
